(19) United States
(12) Patent Application Publication
(10) Pub. No.: US 2004/0125725 A1
(43) Pub. Date: Jul. 1, 2004

(54) Optical disc drive and method of controlling write operation performed by optical disc drive

(75) Inventors: Yuichi Kamioka, Osaka (JP); Yuji Hisakado, Osaka (JP); Toshiya Akagi, Osaka (JP); Chikashi Inokuchi, Osaka (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Matsushita Electric Industrial Co., Ltd.

(21) Appl. No.: 10/625,279

(22) Filed: Jul. 23, 2003

(30) Foreign Application Priority Data
Jul. 24, 2002 (JP) 2002-214764

(51) Int. Cl. G11B 7/00

(52) U.S. Cl. 369/53.34; 369/44.41; 369/44.35; 369/59.21

(57) ABSTRACT

An optical disc drive includes an optical head, a read signal processor, and a controller. The optical head outputs a first read signal representing light reflected from an optical disc and detected at a photodetector. The read signal processor receives the first read signal and outputs the second read signal responsive to a first or second control signal. The second read signal has a predetermined level when output responsive to the first control signal but a level corresponding to that of the first read signal when output responsive to the second control signal. The controller outputs the first and second control signals during first and second periods, respectively. The first period begins before marks are formed on the disc and ends while the marks are formed, and the second period follows the first period. The optical disc drive controls the data write operation in accordance with the second read signal.

### BACKGROUND OF THE INVENTION

1. Field of the Invention

The present invention relates to the technique of controlling a data write operation on an optical disc by detecting light that has been reflected from the optical disc during the write operation.

2. Description of the Related Art

Various types of optical disk storage media (or optical discs) such as a DVD-R and a CD-R are now used extensively to record digital data thereon. Data is recorded on an optical disc by forming pits (or marks) on the recording tracks thereof and defining spaces between those marks. The mark and the space have mutually different reflectances. Thus, by detecting the difference in reflectance, the marks can be easily distinguished from the spaces.

The recording tracks of a DVD-R, a CD-R and other optical discs are wobbled either in a constant period or with the frequency modulated. An optical disc drive for use to write data on such an optical disc generates a reference clock signal based on the wobble frequency for the purpose of controlling the number of revolutions of the optical disc. For example, the optical disc drive disclosed in Japanese Laid-Open Publication No. 7-29179 forms marks on an optical disc by irradiating the optical disc with a laser beam while obtaining a readout signal by detecting the laser beam that has been reflected from the optical disc. In accordance with the readout signal, the optical disc drive controls a data write operation by optical power control, servo control, motor control and write clock control techniques.

FIG. 10 schematically illustrates tracks 802 on a DVD-R on a larger scale. In the example illustrated in FIG. 10, the tracks 802 are guide grooves for use to guide a light spot 804 during a data write operation, and data is written along the guide grooves. As shown in FIG. 10, the guide grooves 802 are wobbled. A region 801 between two adjacent guide grooves 802 is called a “land” or a “land track”, on which marks are formed. Land pre-pits 803 are provided on one side of the lands 801. When these land pre-pits 803 are provided, the optical disc drive can obtain a land pre-pit signal by detecting the reflected light and can control the rotation of the disc by synchronizing the respective timings together. As for a CD-R, the wobble frequency of tracks is subjected to predetermined frequency modulation, thereby obtaining address information. Thus, no pre-pits 803 are provided for a CD-R.

The optical disc drive obtains a push-pull signal by focusing a light beam onto one of grooves 802 and digitizes the push-pull signal at a predetermined slice level, thereby detecting the frequency of the pre-pits 803 and the wobble frequency. Then, the optical disc drive multiplies the wobble frequency by a predetermined number to obtain a write clock signal having a period corresponding to the length of marks 805 per unit time. The optical disc drive normally forms the marks on an optical disc by reference to the land pre-pit signal and synchronously with the write clock signal. Also, based on the wobble frequency detected, the optical disc drive controls the number of revolutions of a disc motor (not shown).

Hereinafter, it will be described how the conventional optical disc drive forms marks on a CD-R. FIG. 11 is a timing diagram showing a conventional method of forming marks on a CD-R (which will be referred to herein as a “first conventional method” for convenience sake). First, the optical disc drive converts write data to be written into a nonreturn-to-zero inverted (NRZI) signal such as that shown in portion (a) of FIG. 11. Next, as the NRZI signal alternates its levels, the optical disc drive selectively irradiates a CD-R with a laser beam with a relatively low intensity (which will be referred to herein as a “weak laser beam”) and a laser beam with a relatively high intensity (which will be referred to herein as a “strong laser beam”). That is to say, when the NRZI signal is low, the optical disc drive irradiates the CD-R with the weak laser beam. On the other hand, when the NRZI signal is high, the optical disc drive irradiates the CD-R with the strong laser beam. As a result, marks are formed on the CD-R every time the CD-R is irradiated with the strong laser beam as shown in portion (b) of FIG. 11.

The optical pickup (not shown) of the optical disc drive detects the laser beam that has been reflected from the optical disc, thereby outputting a read signal such as that shown in portion (c) of FIG. 11. The power of the laser radiation that forms a mark on the CD-R needs to be higher than that of the laser radiation that reads a mark on the CD-R. For that reason, while a mark is being formed on the CD-R, the level of the read signal is also relatively high.

More specifically, when a mark starts being formed on the CD-R by switching the weak laser beam into the strong laser beam, the read signal temporarily has a spike waveform with significantly increased amplitude (as in the period between the times t₁ and t₂ shown in portion (c) of FIG. 11). Thus, the head amplifier (not shown) of the optical pickup outputs the read signal after having adjusted its gain such that the level of the read signal always falls within a predetermined dynamic range even while the read signal has the spike waveform. In this case, the dynamic range is determined in accordance with the performance of the head amplifier or an analog processor, which will process the output signal of the head amplifier.

The optical disc drive derives various types of information from the read signal. More specifically, the optical disc drive obtains servo information for use in a servo control operation, wobbling information about the wobble patterns of the grooves, and running optimum power control (R-OPC) information for use to optimize the laser power constantly during a data write operation. In accordance with these pieces of information collected, the optical disc drive carries out a servo control operation, a motor control operation, an optical power control operation and a write clock generation.

The servo information, the wobbling information and the R-OPC information may be obtained by sampling and holding the read signal in the following manner. As used herein, “to sample” means “to allow the sample-and-hold circuit (not shown) of the optical disc drive to output a signal with a level corresponding to that of its input signal”, and “to hold” means “to allow the sample-and-hold circuit (not shown) of the optical disc drive to output a signal that is held at a predetermined level”. Thus, the sample-and-hold circuit may output the read signal as it is by sampling the read signal or may output a signal that is held at the level of the read signal when the hold operation is started. The sample-and-hold circuit operates in accordance with the sample-and-hold signal. That is to say, when the input signal is sampled (i.e., at S level), the sample-and-hold circuit performs the sample operation. On the other hand, when the input signal is held (i.e., at H level), the sample-and-hold circuit performs the hold operation.

Portion (d) of FIG. 11 shows the waveform of the sample-and-hold signal for use in a servo control operation. This waveform shows the timings to sample and hold the input signal to obtain the servo information. The servo information may be obtained by sampling only an input signal representing a space with at least a predetermined length. Thus, the servo information may be obtained by sampling only a portion of the read signal associated with the weak laser beam and holding a portion of the read signal associated with the strong laser beam.

Portion (e) of FIG. 11 shows the waveform of the sample-and-hold signal for use in a wobble detection operation. This waveform shows the timings to sample and hold the input signal to obtain the wobbling information. The wobbling information may be obtained by sampling an input signal representing every space between marks.

Portion (f) of FIG. 11 shows the waveforms of the sample-and-hold signals for use in an R-OPC operation. These waveforms show the timings to sample and hold the input signal to obtain the R-OPC information. The R-OPC information may be obtained by sampling a portion of the read signal while a mark is being formed but after the spike waveform has disappeared and another portion of the read signal while no mark is being formed.

FIG. 12 is a timing diagram showing how marks are formed on a CD-R that is rotating at a higher velocity than a normal velocity. In performing a write operation at a high speed, the strong and weak laser beams switch themselves at shorter intervals. In a 48× write operation, for example, the time it takes for the beam spot to move the minimum polarity inversion distance of 3T becomes approximately 30 ns as shown in portion (a) of FIG. 12, and a mark is formed every time the CD-R is irradiated with the strong laser beam as shown in portion (b) of FIG. 12. However, if the laser beams switch at the shorter intervals, then a portion A of the waveform of the read signal becomes less sharp just after a mark has been formed, and needs a longer time to settle as shown in portion (c) of FIG. 12. In that case, right after the read signal has settled or even before the read signal has settled, the NRZI signal rises the next time. Then, the read signal cannot be sampled appropriately to perform the servo control and wobble detection as intended.

FIG. 13 is a timing diagram showing how marks are formed on a CD-R by a second conventional method. As in the example described above, when the marks shown in portion (a) of FIG. 13 are formed, the read signal shown in portion (b) of FIG. 13 is obtained. In this method, however, the read signal is not held but smoothed (i.e., averaged) and band-limited. By band-limiting the read signal, a focus/tracking detection signal and a wobble detection signal can be obtained with the influence of the spike waveform reduced. The averaged focus/tracking detection signal and averaged wobble detection signal are shown in portions (c) and (d) of FIG. 13, respectively. By smoothing the overall read signal, the servo information and wobbling information can still be detected just as intended even when the settling time extends due to the high-speed write operation.

However, the R-OPC information must be detected by the first conventional method described above. This is because the R-OPC information cannot be obtained unless a portion of the read signal after the spike waveform has disappeared and another portion of the read signal while no mark is being formed are sampled and unless the other portions of the read signal are held. In reading user data, higher frequency components are needed as compared with the servo control or wobble detection operation. Accordingly, in that case, the head amplifier of the optical pickup is designed so as to have a sufficiently broad pass band.

In the conventional data writing methods, however, the quality of the servo information and wobbling information obtained is too low to perform the servo control, motor control and write clock control operations appropriately. The reasons are as follows.

Specifically, if the gain of the read signal is adjusted such that the entire waveform of the read signal, including the spike waveform portions thereof, falls within the predetermined dynamic range, then the overall level of the read signal drops and the SNR thereof decreases. As a result, the quality of the servo information, wobbling information and R-OPC information becomes too low to perform the servo control, motor control, write clock control and optical power control appropriately. Also, even if the spike waveform portions are removed due to the dynamic range limitation of the circuit, accurate servo information or wobbling information cannot be obtained because those pieces of information have been altered due to the removal of the spike waveform portions.

On the other hand, even if the overall read signal is smoothed, the spike waveform portions thereof cannot be eliminated completely. Thus, the smoothed read signal should be so seriously affected by the spike waveform portions including a lot of high-frequency components that no accurate servo information or wobbling information can be obtained.

These problems are troublesome particularly when data should be written at a high speed. This is because if the intensity of the laser beam is increased to form marks at a higher rate, the various types of control information are affected by the spike waveform portions of the read signal even more seriously.

### SUMMARY OF THE INVENTION

In order to overcome the problems described above, preferred embodiments of the present invention provide an apparatus and method for controlling a data write operation appropriately by servo control, write clock control, motor control and/or optical power control techniques.

An optical disc drive according to a preferred embodiment of the present invention is used to perform a data write operation on an optical disc by irradiating the optical disc with light such that a plurality of marks are formed on the optical disc. The optical disc drive preferably includes an optical head, a read signal processor, and a controller. The optical head preferably includes a light source and a photodetector and preferably outputs a first read signal by getting the light emitted from the light source, reflected from the optical disc, and then detected by the photodetector. The read signal processor preferably processes the first read signal received into a second read signal and preferably outputs the second read signal in response to either a first control signal or a second control signal. The second read signal output by the read signal processor in response to the first control signal preferably is held at a predetermined level, while the second read signal output by the read signal processor in response to the second control signal preferably has a level corresponding to that of the first read signal. The controller preferably generates the first and second control signals and preferably outputs the first control signal during a first period and the second control signal during a second period following the first period, respectively. The first period preferably begins before the marks are formed and preferably ends while the marks are being formed. The optical disc drive preferably controls the data write operation in accordance with the second read signal that has been output from the read signal processor.

In one preferred embodiment of the present invention, the first read signal may exhibit a spike waveform during the first period, and the controller may generate the second control signal after the spike waveform has disappeared.

In this particular preferred embodiment, the controller preferably determines, by the amount of time that has passed since light having an intensity high enough to form the marks started to be emitted from the light source, whether the spike waveform has disappeared or not.

More specifically, the read signal processor preferably defines the predetermined value to be lower than the level of the spike waveform.

In another preferred embodiment, the optical head may output the first read signal by cutting off its waveform portions having levels that exceed a predetermined dynamic range.

In that case, the optical head preferably outputs the first read signal by cutting off portions of the spike waveform.

More particularly, the optical head preferably outputs the first read signal having a gain that falls within the predetermined dynamic range.

In still another preferred embodiment, the optical disc drive may further include an averaging processor for averaging the second read signal received from the read signal processor and outputting an averaged second read signal. Then, the optical disc drive preferably controls the data write operation in accordance with the averaged second read signal.

In yet another preferred embodiment, the optical disc drive may control the data write operation by at least one of servo control, write clock control, motor control, and optical power control techniques.

A data writing method according to a preferred embodiment of the present invention is preferably a method of performing a data write operation on an optical disc by irradiating the optical disc with light such that a plurality of marks are formed on the optical disc. The method preferably includes the steps of: detecting the light that has been emitted from a light source and then reflected from the optical disc; outputting a first read signal that represents the light detected; and processing the first read signal into a second read signal and outputting the second read signal in response to either a first control signal or a second control signal. In this process step, the second read signal being output in response to the first control signal is preferably held at a predetermined level, while the second read signal being output in response to the second control signal preferably has a level corresponding to that of the first read signal. The method preferably further includes the step of generating the first and second control signals and outputting the first control signal during a first period and the second control signal during a second period following the first period, respectively. In this process step, the first period preferably begins before the marks are formed and preferably ends while the marks are being formed. The method preferably further includes the step of controlling the data write operation in accordance with the second read signal.

A computer program product according to a preferred embodiment of the present invention is preferably used with executed by an optical disc drive. The optical disc drive preferably includes an optical head, a read signal processor and a controller and preferably performs a data write operation on an optical disc by irradiating the optical disc with light such that a plurality of marks are formed on the optical disc. The optical head preferably includes a light source that emits the light and a photodetector that detects the light. The computer program product may cause the optical disc drive to perform steps of: emitting the light from the light source; detecting the light, which has been reflected from the optical disc, by means of the photodetector; outputting a first read signal, representing the light detected, from the optical head; and generating a second read signal output from the read signal processor in response to one of a first control signal and a second control signal. In this step, the second read signal being output in response to the first control signal is preferably held at a predetermined level, while the second read signal being output in response to the second control signal preferably has a level corresponding to that of the first read signal. The program preferably further includes the step of generating the first and second control signals at the controller during a first period and during a second period following the first period, respectively. In this step, the first period preferably begins before the marks are formed and preferably ends while the marks are being formed. The program preferably further includes the step of controlling the data write operation in accordance with the second read signal.

A control processor according to a preferred embodiment of the present invention is preferably included in an optical disc drive and preferably selectively operates either in a first operation mode or in a second operation mode. The optical disc drive preferably performs a data write operation on an optical disc by irradiating the optical disc with light such that a plurality of marks are formed on the optical disc. The optical disc drive preferably includes an optical head and a read signal processor. The optical head preferably includes a light source and a photodetector and preferably outputs a first read signal by getting the light emitted from the light source, reflected from the optical disc, and then detected by the photodetector. The read signal processor preferably processes the first read signal received into a second read signal and preferably outputs the second read signal in response to either a first control signal or a second control signal. The second read signal output by the read signal processor in response to the first control signal is preferably held at a predetermined level, while the second read signal output by the read signal processor in response to the second control signal preferably has a level corresponding to that of the first read signal. While operating in the first operation mode, the control processor preferably generates and outputs the first control signal during a first period and the second control signal during a second period following the first period, respectively. The first period preferably begins before the marks are formed and preferably ends while the marks are being formed. On the other hand, while operating in the second operation mode, the control processor preferably generates and outputs the first control signal during a third period and the second control signal during a fourth period following the third period, respectively. The third period preferably does not overlap with the first period.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a block diagram showing a configuration for an optical disc drive according to the first specific preferred embodiment of the present invention.

FIG. 2 is a block diagram showing a configuration for a photodetector and a head amplifier that are included in the optical pickup shown in FIG. 1.

FIG. 3 is a block diagram showing a configuration for the focus/tracking servo regulator shown in FIG. 1.

FIG. 4 is a block diagram showing a configuration for the wobble detector shown in FIG. 1.

FIG. 5 is a block diagram showing a configuration for the R-OPC detector shown in FIG. 1.

FIG. 6 is a timing diagram showing how marks are formed on recording tracks of an optical disc.

FIG. 7 is a flowchart showing how sample-and-hold processing is carried out on a read signal to be generated while the marks are being formed.

FIG. 8 is a timing diagram showing how a processed signal is generated in the optical disc drive of the first preferred embodiment.

FIG. 9 is a block diagram showing a configuration for an optical disc drive according to the second specific preferred embodiment of the present invention.

FIG. 10 is a perspective view schematically illustrating recording tracks of a DVD on a larger scale.

FIG. 11 is a timing diagram showing how marks are formed on a CD-R by the first conventional method.

FIG. 12 is a timing diagram showing how marks are formed on a CD-R that is rotating at a higher velocity than a normal velocity.

FIG. 13 is a timing diagram showing how marks are formed on a CD-R by the second conventional method.

### DETAILED DESCRIPTION OF PREFERRED EMBODIMENTS

Hereinafter, preferred embodiments of an optical disc drive according to the present invention will be described with reference to the accompanying drawings. An optical disc drive according to a preferred embodiment of the present invention can read and write data from/on an optical disc. In performing a data write operation, while writing data on the optical disc, the optical disc drive also reads the data from the disc to obtain a read signal and controls the data write operation in accordance with the read signal.

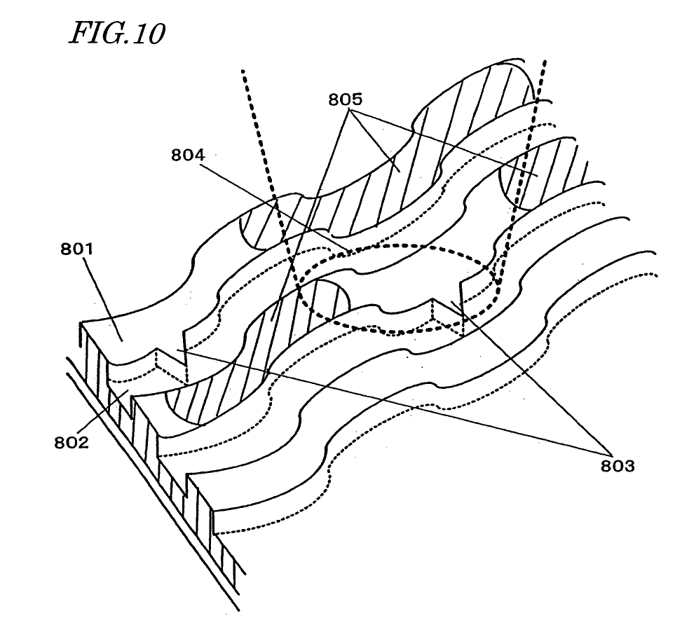

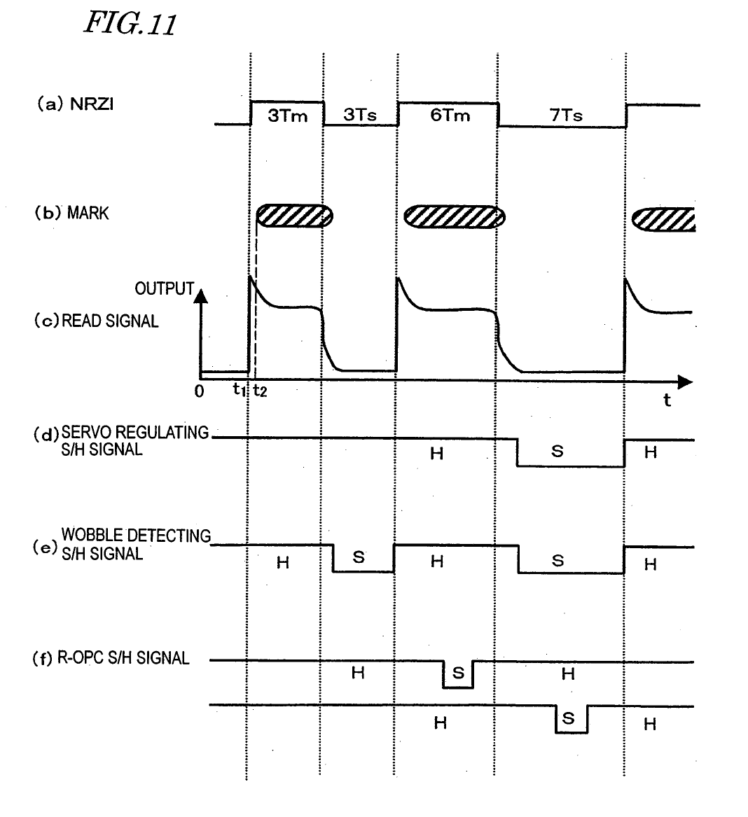

First, an optical disc for use in an optical disc drive according to a preferred embodiment of the present invention will be described. The optical disc is preferably a disk storage medium such as a CD-R or a DVD-R and preferably has a plurality of recording tracks thereon. FIG. 10 schematically illustrates the recording tracks 801 of a DVD-R. Each recording track may be defined as a region between two adjacent guide grooves 802. The recording tracks include a recording film made of a phase change material. When an optical disc is irradiated with a laser beam having a predetermined wavelength, the irradiated portion of the recording film changes its physical properties, thereby forming a mark thereon. The laser beam is radiated from the optical disc drive for a predetermined period of time, and its timings and intensity are determined in accordance with the write data to be written on the optical disc. A portion of the optical disc on which a mark has been formed has a different reflectance from another portion of the optical disc on which no mark has been formed and which is located between two adjacent marks (i.e., a space). Thus, by detecting the difference in reflectance, the optical disc drive can distinguish the marks and spaces on the recording tracks from each other and can read the write data.

If the optical disc is a DVD-CR or a CD-R, the recording tracks thereof are provided so as to wobble at a predetermined frequency. In the example illustrated in FIG. 10, the recording tracks are also wobbled. However, a DVD-R has a constant wobble frequency but a CD-R has its wobble frequency modulated. The wobble frequency is used to generate a reference clock signal for use to control the number of revolutions of the optical disc.

Furthermore, in a DVD-R, the recording tracks thereof are provided with land pre-pits 803. Data is normally written on a DVD-R by reference to a land pre-pit signal representing the land pre-pits 803 and synchronously with a write clock signal that has been generated by detecting the wobble frequency. On the other hand, if the optical disc is a CD-R, the wobble frequency is subjected to a constant frequency modulation to obtain address information. Thus, no pre-pits 803 are provided for a CD-R.

Embodiment 1

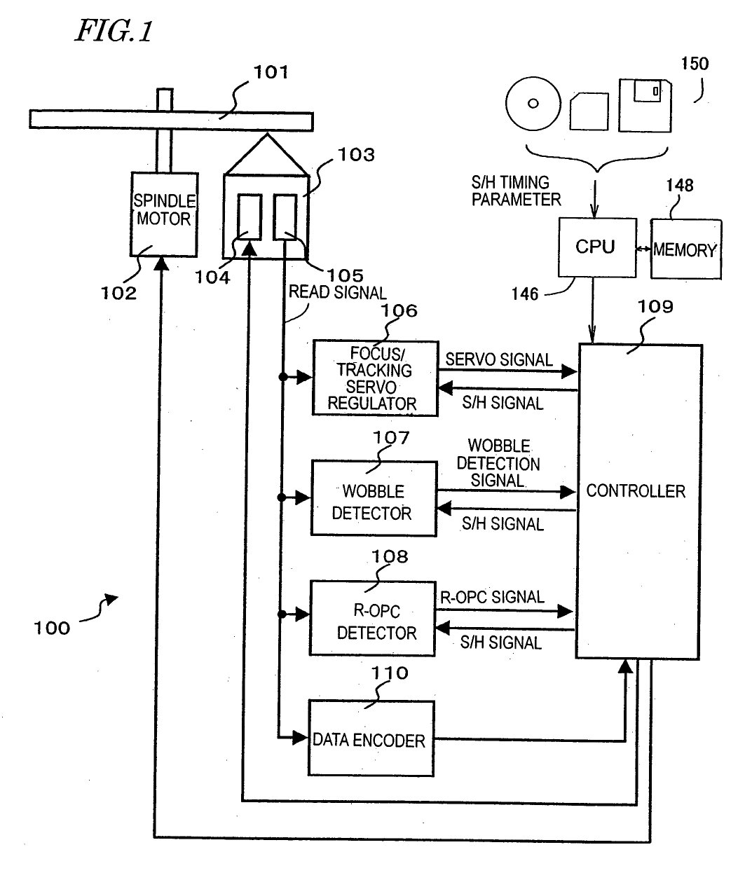

FIG. 1 is a block diagram showing a configuration for an optical disc drive 100 according to the first specific preferred embodiment of the present invention. The optical disc drive 100 is used to read and write data from/on an optical disc 101, which may be a CD-R, for example. These read and write operations are preferably carried out on a computer program, which was read out from any of various storage media 150 and installed in this optical disc drive 100. FIG. 1 illustrates the optical disc 101 and various types of storage media 150 just for convenience sake. It should be noted, however, that these media 101 and 150 are not indispensable elements of the optical disc drive 100 but mere optional components.

As shown in FIG. 1, the optical disc drive 100 preferably includes a spindle motor 102, an optical pickup 103, a focus/tracking servo regulator 106, a wobble detector 107, an R-OPC detector 108, a data encoder 110, a controller 109, a central processing unit (CPU) 146 and a memory 148.

The spindle motor 102 rotates the optical disc 101 at a rotational velocity as specified by the controller 109. If the spindle motor 102 increases the rotational velocity of the disc 101 to more than its normal velocity during a data read or write operation, then the read or write operation can be carried out at a high speed.

In writing data on the optical disc 101, the optical pickup 103 irradiates the optical disc 101 with a laser beam having a predetermined wavelength, thereby forming a plurality of marks on the optical disc 101. As described above, those marks are formed by locally changing the physical properties of the recording film on the recording tracks. The optical pickup 103 also detects the laser beam that has been reflected from the optical disc 101, thereby outputting a read signal.

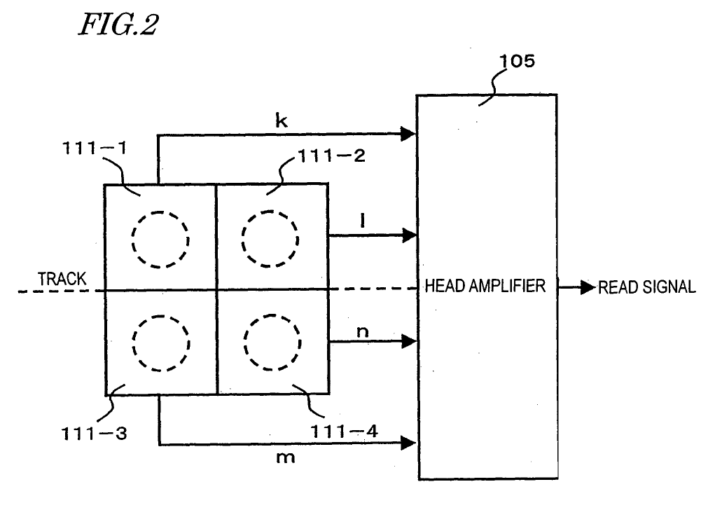

The optical pickup 103 includes a laser driver 104, a light source (not shown), a photodetector (see FIG. 2), and a head amplifier 105. The laser driver 104 receives a digital nonreturn-to-zero inverted (NRZI) signal, obtained by converting write data to be written, from the controller 109. In accordance with the NRZI signal, the laser driver 104 transforms the recording power into a drive current and supplies the drive current to the light source (e.g., a laser diode). Then, the light source emits a laser beam, having a predetermined power corresponding to the magnitude of the drive current, toward the optical disc 101. The light source may radiate a laser beam with a low intensity if the NRZI signal is low and a laser beam with a high intensity if the NRZI signal is high, for example. The marks are formed on the optical disc 101 when the recording tracks are exposed to the laser beam with the high intensity.

The photodetector of the optical pickup 103 detects the laser beam that has been reflected from the optical disc 101 and outputs a read signal representing the intensity of the laser beam detected. FIG. 2 is a block diagram showing the photodetector 111 (consisting of four detecting areas 111-1, 111-2, 111-3 and 111-4) and the head amplifier 105 that are included in the optical pickup 103. In the example shown in FIG. 2, the photodetector 111 and the head amplifier 115 are illustrated as two separate components. Alternatively, the photodetector 111 and the head amplifier 115 may be integrated together into a monolithic component to increase the transfer rate.

The relative positions of the respective detecting areas 111-1, 111-2, 111-3 and 111-4 of the photodetector 111 are controlled so as to satisfy a predetermined positional relationship with a recording track on which the laser beam is currently being focused. More specifically, the position of the optical pickup 103 is controlled such that the detecting areas 111-1 and 111-2 are located more distant from the center of the disc 101 than the recording track on which the laser beam is now being focused and that the detecting areas 111-3 and 111-4 are located closer to the center of the disc 101 than that recording track. Ideally, the laser beam that has been reflected from the centerline of the recording track should be incident onto the division line between the upper pair of detecting areas 111-1, 111-2 and the lower pair of detecting areas 111-3, 111-4. In performing a data write operation, the respective detecting areas 111-1, 111-2, 111-3 and 111-4 of the photodetector 111 detect the intensities of the laser beam that has been reflected from the optical disc 101 as current values, thereby outputting signals k, l, m and n representing the currents detected.

The head amplifier 105 receives the output signals k, l, m and n of the respective detecting areas 111-1, 111-2, 111-3 and 111-4 of the photodetector 111, converts these current signals into voltage signals, and then outputs the resultant voltage signals. These voltage signals will be used as read signals in subsequent processing steps. In FIG. 2, the read signal is illustrated as a single signal. Actually, though, four voltage signals, corresponding to the output signals k, l, m and n of the respective detecting areas 111-1, 111-2, 111-3 and 111-4 of the photodetector 111, are output. It should be noted, however, that even the four signals that have actually been converted and output by the head amplifier 105 will also be referred to herein as “output signals k, l, m and n” for the sake of convenience. Also, the “dynamic range” to be mentioned later is determined by the performances of the detecting areas 111-1 through 111-4 of the photodetector 111, head amplifier 105 and an analog processor, which is provided so as to receive the output of the head amplifier 105.

Other components of the optical disc drive 100 will be described with reference to FIG. 1 again. The focus/tracking servo regulator 106 receives the read signal from the optical pickup 103 and a sample-and-hold signal from the controller 109, respectively, generates a servo signal for use in a servo control operation (i.e., servo information) and outputs the servo signal to the controller 109. The servo information includes tracking information for use in a tracking control operation and focus information for use in a focus control operation. The wobble detector 107 also receives the read signal from the optical pickup 103 and the sample-and-hold signal from the controller 109, respectively, generates a wobble detection signal representing the wobble frequency detected (i.e., wobbling information) and then outputs the wobble detection signal to the controller 109. The wobbling information includes information about the wobble frequency. The R-OPC detector 108 also receives the read signal from the optical pickup 103 and the sample-and-hold signal from the controller 109, respectively, generates a running optimum power control (R-OPC) signal (i.e., R-OPC information) and then outputs the R-OPC signal to the controller 109. The R-OPC information is used to optimize the laser power constantly during a data write operation. The “sample-and-hold signal” is a control signal for use to control the operations of respective components of the optical disc drive, and may be separated into a sampled signal and a held signal as will be described later.

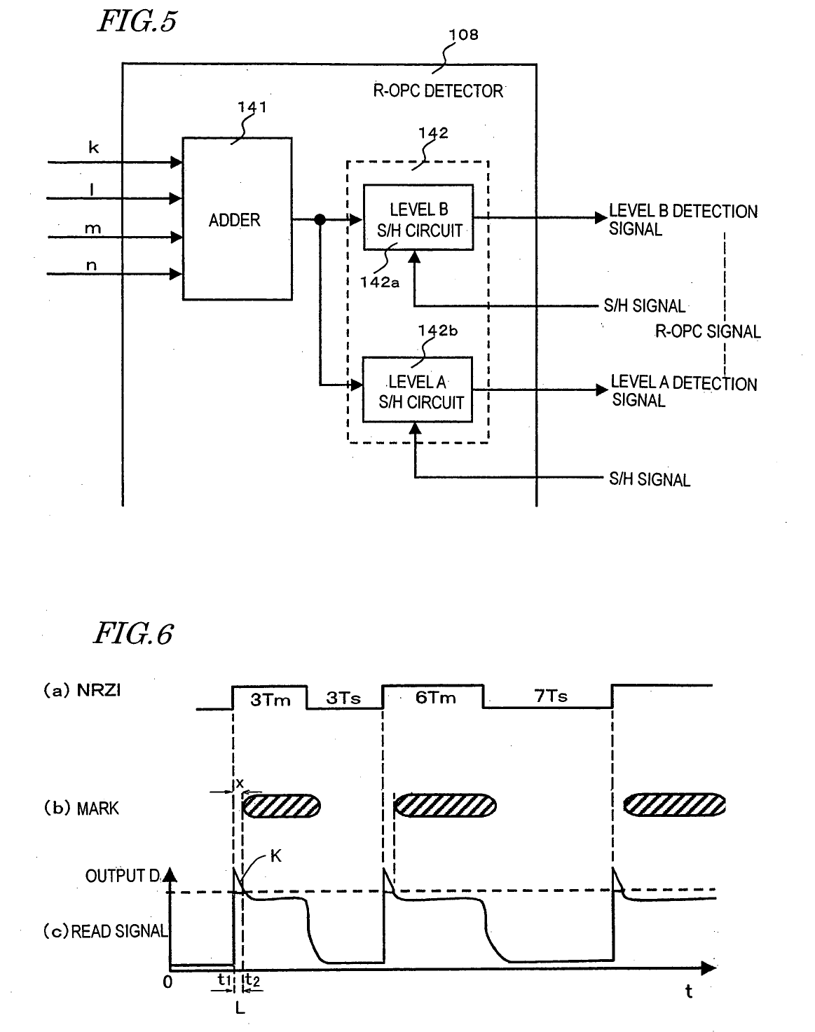

The controller 109 converts the write data to be written into an NRZI signal (see portion (a) of FIG. 6) and then outputs the NRZI signal to the optical pickup 103. Also, the controller 109 outputs the sample-and-hold (S/H) signal, which is used to control a sample-and-hold operation, to the focus/tracking servo regulator 106, wobble detector 107 and R-OPC detector 108 and receives the servo signal, wobble detection signal and R-OPC signal. By using these signals, the controller 109 controls the data write operation (e.g., generates and controls a write clock signal, controls the optical power to be applied onto the optical disc 101, performs a servo control on the optical pickup 103 and controls the spindle motor 102).

In this preferred embodiment, the sample-and-hold signal being output from the controller 109 preferably alternates between a high level and a low level. In accordance with an S/H timing parameter that has been defined by the CPU 146, the controller 109 adjusts the timings, at which the levels of the sample-and-hold signal are switched, for the respective destinations of the sample-and-hold signal.

The CPU 146 is preferably a microprocessor that controls the overall operation of the optical disc drive 100. The CPU 146 executes a computer program that is stored in the memory 148, thereby instructing the controller 109 to operate according to the procedure that is defined by the computer program. This computer program also includes the S/H timing parameter that defines the timings at which the controller 109 should switch the sample-and-hold signal from the high level into the low level, or vice versa.

The computer program may be stored in any of various types of storage media 150. Examples of the storage media 150 include optical storage media such as optical discs, semiconductor storage media such as an SD memory card, and magnetic recording media such as a flexible disk. In any case, when the storage medium 150 is loaded into the optical disc drive 100, the computer program is read out from the storage medium 150 and then stored in the memory 148 under the control of the CPU 146. The memory 148 may be a non-volatile memory such as an EEPROM, for example. In the preferred embodiment illustrated in FIG. 1, the computer program is installed in the optical disc drive 100 by way of the storage medium 150. Alternatively, the computer program may also be downloaded via a telecommunications line (e.g., through the Internet, for example) and installed in the optical disc drive 100.

The data encoder 110 encodes the read signal to obtain user data recorded on the optical disc 101.

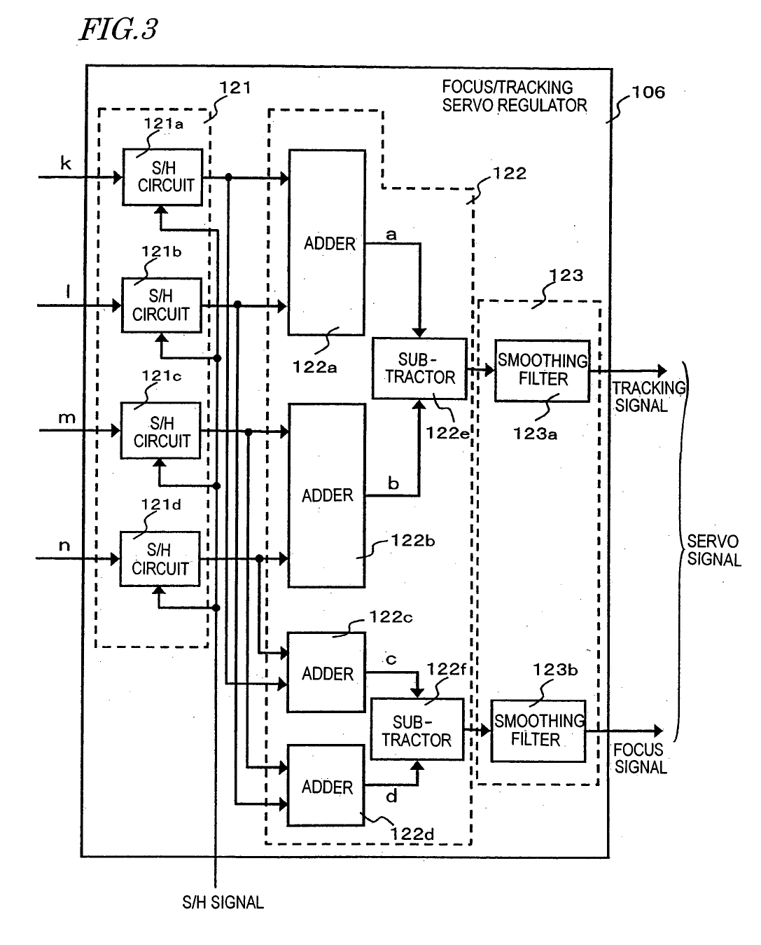

Next, specific configurations for the focus/tracking servo regulator 106, wobble detector 107 and R-OPC detector 108 will be described with reference to FIGS. 3 through 5.

FIG. 3 is a block diagram showing a specific configuration for the focus/tracking servo regulator 106. In response to the read signals k, l, m and n, the focus/tracking servo regulator 106 generates a tracking signal for use in a tracking control operation and a focus signal for use in a focus control operation.

As shown in FIG. 3, the focus/tracking servo regulator 106 preferably includes a sample-and-hold section 121, an adding/subtracting section 122 and a smoothing section 123. The sample-and-hold section 121 receives the read signals k, l, m and n from the optical pickup 103 and the sample-and-hold signal from the controller 109, respectively, and samples or holds, and outputs the read signals k, l, m and n in response to the sample-and-hold signal. In this case, the sample-and-hold section 121 may be regarded as subjecting the read signals received to predetermined processing and outputting the processed signals. In the description of preferred embodiments, “to sample” and “to hold” are also used as already defined in the background of the invention. Thus, when sampling the read signals, the sample-and-hold section 121 outputs the read signals as they are. On the other hand, when holding the read signals, the sample-and-hold section 121 outputs signals that are held at the levels of the read signals at a predetermined point in time.

One of the principal features of the present invention is to obtain a signal with no unnecessary waveforms from a read signal by adjusting the sampling and holding timings. A tracking signal and a focus signal of quality can be obtained from such a signal and therefore the data write operation can be controlled just as intended. The timings to sample and hold the read signals will be described later with reference to FIGS. 6 through 8.

The adding/subtracting section 122 performs a predetermined arithmetic operation on the sampled and held read signals and then outputs the results. The smoothing section 123 smoothes (or averages) the output signals of the adding/subtracting section 122 and then outputs the smoothed signals as the tracking signal and the focus signal to the controller 109.

The operation of the focus/tracking servo regulator 106 will be described in further detail. The sample-and-hold section 121 includes sample-and-hold circuits 121a, 121b, 121c and 121d, which receive and sample or hold the read signals k, l, m and n, respectively. These sample-and-hold circuits 121a through 121d perform the sample-and-hold operations in response to the sample-and-hold signal supplied from the controller 109.

The adding/subtracting section 122 includes adders 122a, 122b, 122c and 122d and subtractors 122e and 122f. The adder 122a adds together the sampled and held read signals k and l that were obtained at the detecting areas 111-1 and 111-2 closer to the outer periphery of the optical disc 101, thereby outputting a signal a representing the sum of the two read signals k and l. On the other hand, the adder 122b adds together the sampled and held read signals m and n that were obtained at the detecting areas 111-3 and 111-4 closer to the inner periphery of the optical disc 101, thereby outputting a signal b representing the sum of the two read signals m and n. The adder 122c adds together the sampled and held read signals k and n that were obtained at the two diagonally adjacent detecting areas 111-1 and 111-4, thereby outputting a signal c representing the sum of the two read signals k and n. On the other hand, the adder 122d adds together the sampled and held read signals l and m that were obtained at the two diagonally adjacent detecting areas 111-2 and 111-3, thereby outputting a signal d representing the sum of the two read signals l and m. The subtractor 122e subtracts the output signal b of the adder 122b from the output signal a of the adder 122a. On the other hand, the subtractor 122f subtracts the output signal d of the adder 122d from the output signal C of the adder 122c.

As a result of these arithmetic operations, the subtractor 122e outputs a signal representing to which side (i.e., inner periphery or the outer periphery) the reflected light is closer with respect to the target track. That is to say, the output signal of the subtractor 122e also represents whether the laser beam that has been radiated toward the optical disc 101 is closer to the inner periphery or the outer periphery with respect to the target track. If the output signal of the subtractor 122e is approximately equal to zero, then the beam spot of the laser radiation should be located right on the target track. However, if the output signal of the subtractor 122e has a positive or negative value and if the absolute value thereof is equal to or greater than a predetermined value, then the beam spot of the laser radiation has deviated from the target track either inward or outward. On the other hand, the subtractor 122f outputs a signal representing the spot shape of the reflected and projected beam. For example, if the output signal of the subtractor 122f is approximately equal to zero, then the spot shape of the reflected and projected beam is almost completely round and the laser beam should be right in focus with the target recording track. However, if the output signal of the subtractor 122f has a positive or negative value and if the absolute value thereof is equal to or greater than a predetermined value, then the spot shape of the reflected and projected beam is ellipsoidal and the laser beam should be out of focus with the target recording track. Also, it can also be seen by the sign of the output signal of the subtractor 122f whether the focal point of the laser beam is located deeper or shallower than the target recording track.

The smoothing section 123 functions as a so-called “low-pass filter”. If the optical disc 101 is a CD-R, then the smoothing section 123 may be a filter that passes frequencies that are at most equal to about 100 kHz. The smoothing section 123 includes two smoothing filters 123a and 123b, which smooth the output signals of the subtractors 122e and 122f, thereby outputting a smoothed tracking signal and a smoothed focus signal, respectively.

Following such an operating principle, the focus/tracking servo regulator 106 performs a tracking control operation (i.e., control of the spot of the laser beam in the radial direction of the optical disc 101) by using the tracking signal and a focus control operation (i.e., control of the focal point of the laser beam perpendicularly to the recording plane of the optical disc 101) by using the focus signal, respectively.

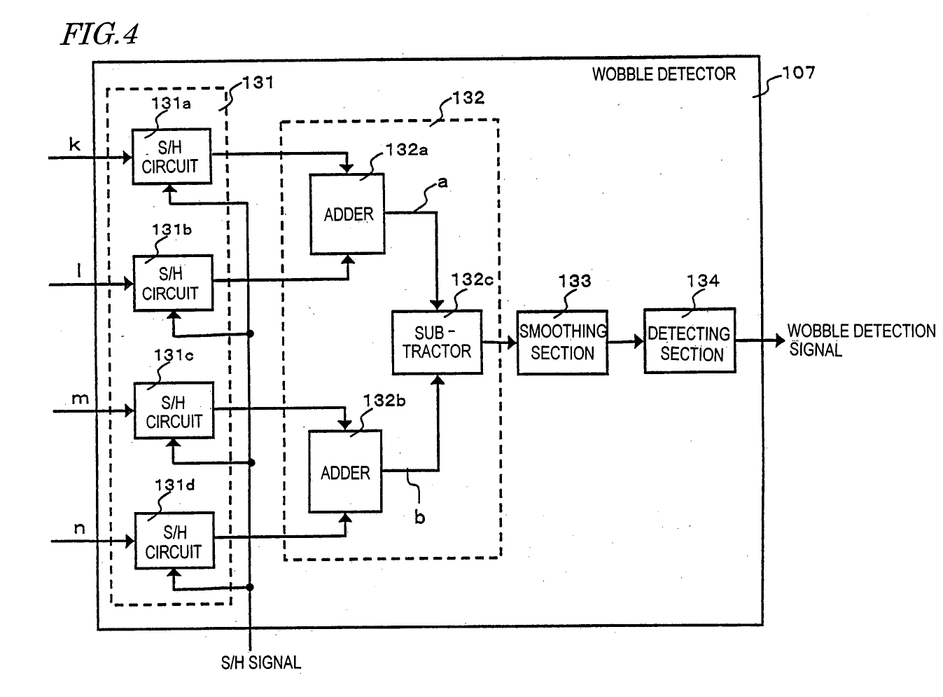

FIG. 4 is a block diagram showing a configuration for the wobble detector 107. In accordance with the read signals k, l, m and n, the wobble detector 107 generates a wobble detection signal that specifies the wobble frequency of the recording tracks. Thus, a reference clock signal for use to control the number of revolutions of the optical disc can be obtained from the wobble detection signal.

As shown in FIG. 4, the wobble detector 107 preferably includes a sample-and-hold section 131, an adding/subtracting section 132, a smoothing section 133 and a detecting section 134. The sample-and-hold section 131 receives the read signals k, l, m and n from the optical pickup 103 and the sample-and-hold signal from the controller 109, respectively, and samples or holds and outputs the read signals k, l, m and n in response to the sample-and-hold signal. In this case, the sample-and-hold section 131 may be regarded as subjecting the read signals received to predetermined processing and outputting the processed signals. The adding/subtracting section 132 performs a predetermined arithmetic operation on the sampled and held read signals and then outputs the result. The smoothing section 133 smoothes (or averages) the output signal of the adding/subtracting section 132. And the detecting section 134 obtains and outputs a wobble detection signal based on the smoothed read signal.

Just like the focus/tracking servo regulator 106 described above, the wobble detector 107 can also output a wobble detection signal of quality by using the sample-and-hold signal to regulate the timings to sample and hold the read signals. The timings to sample and hold the read signals will be described later with reference to FIGS. 6 through 8.

The operation of the wobble detector 107 will be described in further detail. The sample-and-hold section 131 includes sample-and-hold circuits 131a, 131b, 131a and 131d, which receive and sample or hold the read signals k, l, m and n, respectively. These sample-and-hold circuits 131a through 131d perform the sample-and-hold operations in response to the sample-and-hold signal supplied from the controller 109.

The adding/subtracting section 132 includes adders 132a and 132b and a subtractor 132c. The adder 132a adds together the sampled and held read signals k and l, thereby outputting a signal a. On the other hand, the adder 132b adds together the sampled and held read signals m and n, thereby outputting a signal b. The subtractor 132c outputs a signal representing the difference between the signals a and b. As the recording track wobbles, the quantity of light impinging on each of the four areas 111-1 through 111-4 of the photodetector 111 changes in a predetermined period. Specifically, as the quantity of reflected light incident on the detecting areas 111-1 and 111-2 that are closer to the outer periphery of the optical disc 101 (which will be referred to herein as “outer detecting areas 111-1 and 111-2”) increases, the quantity of reflected light incident on the detecting areas 111-3 and 111-4 that are closer to the inner periphery of the optical disc 101 (which will be referred to herein as “inner detecting areas 111-3 and 111-4”) decreases. Stated otherwise, as the quantity of light falling on the outer detecting areas 111-1 and 111-2 decreases, the quantity of light falling on the inner detecting areas 111-3 and 111-4 increases. The frequency of this increase or decrease in the quantity of light falling on each pair of detecting areas represents the wobble frequency. Thus, the output differential signal of the subtractor 132c is a signal representing the wobble pattern of the recording tracks and the frequency thereof represents the wobble frequency.

The smoothing section 133 functions as a so-called “bandpass filter”. If the optical disc 101 is a CD-R and is rotating at a reference velocity, then the smoothing section 133 may be a filter that passes frequencies around 20 kHz. The smoothing section 133 smoothes the output differential signal of the subtractor 132c. The detecting section 134 digitizes the smoothed signal at a predetermined slice level to obtain a digital signal and then outputs the wobble detection signal in accordance with the frequency of the digital signal. By using this wobble detection signal, the wobble frequency of the recording tracks on the optical disc 101 can be detected.

FIG. 5 is a block diagram showing a configuration for the R-OPC detector 108. In accordance with the read signals k, l, m and n, the R-OPC detector 108 generates an R-OPC signal, which is needed to perform the control operation of optimizing the laser power constantly during a data write operation.

As shown in FIG. 5, the R-OPC detector 108 includes an adder 141 and a sample-and-hold section 142. The adder 141 adds all of the four read signals k, l, m and n together and outputs a signal representing the sum. Since all four read signals k, l, m and n are added together, the output signal of the adder 141 represents all of the light detected. The sample-and-hold section 142 includes a level B sample-and-hold circuit 142a and a level A sample-and-hold circuit 142b. The level B and level A sample-and-hold circuits 142a and 142b receive the sum signal from the adder 141 and the sample-and-hold signal from the controller 109, respectively, and sample or hold the sum signal in response to the sample-and-hold signal.

The level B sample-and-hold circuit 142a samples a value of the read signal while a strong laser beam is being radiated during a data write operation and then outputs the resultant level B detection signal to the controller 109. The level B sample-and-hold circuit 142a may sample a value of the read signal while the strong laser beam is being radiated and after the spike waveform has disappeared, for example. The spike waveform will be described later with reference to FIG. 6. On the other hand, the level A sample-and-hold circuit 142b samples a value of the read signal while a weak laser beam is being radiated during a data write operation and then outputs the resultant level A detection signal to the controller 109. The level A sample-and-hold circuit 142b may sample a value of the read signal representing a space on the recording track on which a weak laser beam is being focused, for example. The controller 109 receives the level B detection signal and the level A detection signal from the sample-and-hold section 142 and controls the laser recording power such that the ratio of the two detection signals equals a predetermined value during a write operation. However, a control operation may also be carried out in a different way by using the R-OPC signal. For example, the power of the laser radiation may also be controlled so as to make only the level B detection signal constant.

As described above, the controller 109 controls the data write operation in accordance with the various types of information that have been gained from the focus/tracking servo regulator 106, wobble detector 107 and R-OPC detector 108. These pieces of information are obtained by subjecting the read signals to the predetermined sample-and-hold processing and then performing the predetermined arithmetic operations on the sampled and held signals. Accordingly, the quality of the resultant signals (i.e., the accuracy of the information obtained) heavily depends on the timings to sample and hold the read signals.

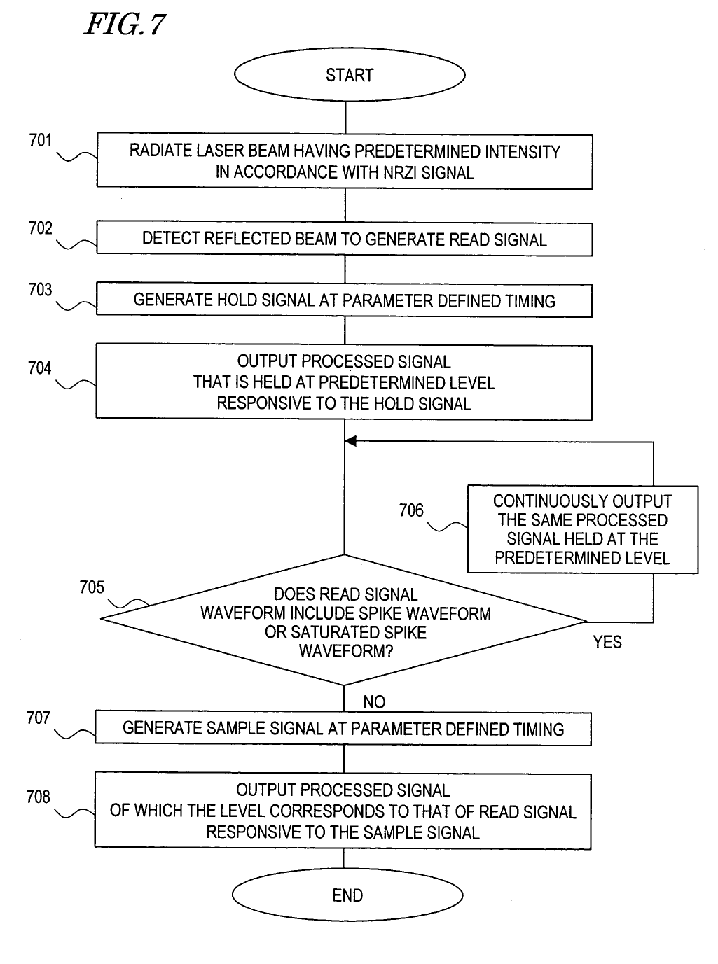

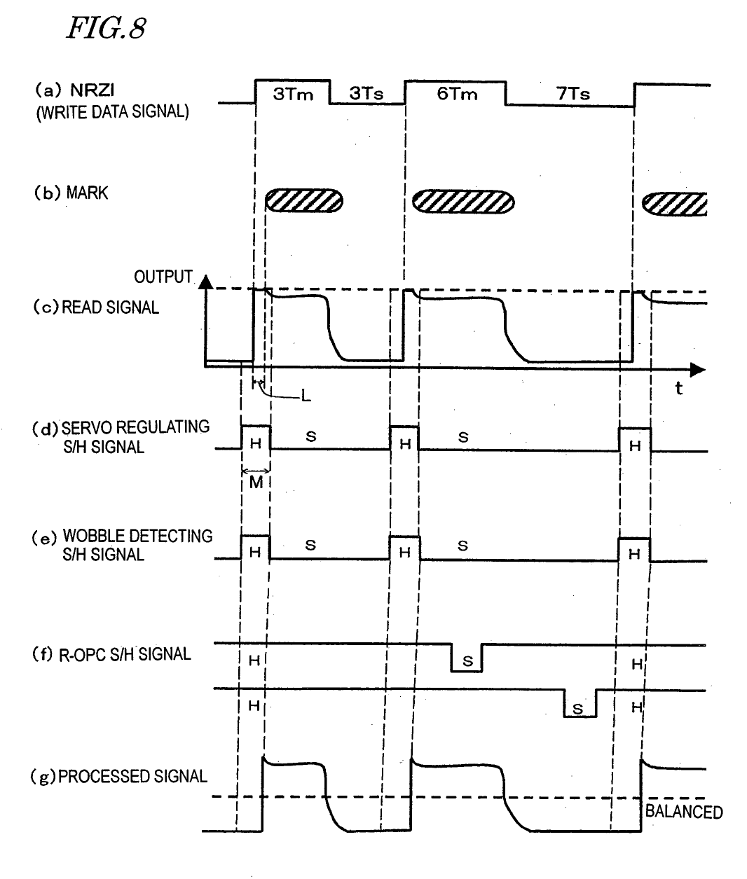

Thus, first, it will be described with reference to FIG. 6 how the spike waveform deteriorates the quality of a read signal. After that, it will be described with reference to FIGS. 7 and 8 how the optical disc drive 100 carries out the sample-and-hold processing to obtain highly reliable and accurate information.

FIG. 6 is a timing diagram showing how marks are formed on the recording tracks of the optical disc 101. In accordance with the NRZI signal (shown in portion (a) of FIG. 6) that has been generated by the controller 109, the optical pickup 103 radiates the laser beam, thereby forming marks on the recording tracks of the optical disc 101. In this case, when the NRZI signal is high, a strong laser beam is radiated to form a mark as shown in portion (b) of FIG. 6. On the other hand, when the NRZI signal is low, a weak laser beam is radiated and no marks are formed.

As can be seen from portion (b) of FIG. 6, even when the strong laser beam starts to be radiated on a leading edge of the NRZI signal, the mark does not start being formed immediately. Instead, a predetermined time delay x is inevitable before the formation of the mark gets started. This delay x is brought about because it takes some time to produce a physical change in the recording track due to the exposure to the strong laser beam and because the optical disc 101 does not stop rotating in the meantime. In the interval defined by this delay x, the reflectance becomes relatively high. Accordingly, when the strong laser beam is radiated during this short interval, the read signal will have a locally significantly increased level. As a result., the read signal exhibits the spike waveform. When the minimum polarity inversion distance is 3T, the delay x may be approximately equal to 1.5T, for example.

Portion (c) of FIG. 6 shows the waveform of the read signal including the spike waveform K. In the example illustrated in FIG. 6, the strong laser beam starts being radiated at a time t₁ and the mark starts being formed at a time t₂. Then, in the interval L (=t₂−t₁) corresponding to the time delay x, the read signal has a locally significantly increased level, or the spike waveform K. The interval L normally has a length of several tens to several hundreds of nanoseconds. In a CD-R, for example, the interval L is about 300 nsec for a normal write speed and about 150 nsec for a 2× write speed. In a DVD-R on the other hand, the interval L is about 50 nsec for a normal write speed and about 25 nsec for a 2× write speed.

The optical pickup 103 of this preferred embodiment cannot detect a portion of the spike waveform, which is produced just before a mark starts being formed and which has a level exceeding the predetermined dynamic range. Such a non-detectable portion of the spike waveform will be referred to herein as a “saturated spike waveform K”. Thus, the optical pickup 103 outputs a read signal from which the saturated spike waveform K has been removed (such a read signal will also be referred to herein as a “read signal with the saturated spike waveform K masked”). Furthermore, the optical pickup 103 adjusts the gain such that the remaining waveform portions, other than the saturated spike waveform K, fall within the dynamic range and then outputs the read signal. The dynamic range may be defined between zero and D as shown in portion (c) of FIG. 6. It should be noted that if there is no saturated spike waveform K, then a read signal including the spike waveform will be output.

The read signal, from which the saturated spike waveform has been removed, has relatively high levels because the highest level thereof is close to the upper limit of the dynamic range. In the same way, the read signal, from which no saturated spike waveform has been removed, locally has a high level because the read signal still includes the spike waveform. Accordingly, if a write operation is controlled based on any of such read signals, then the result may sometimes be inappropriate.

Thus, the optical disc drive 100 of this preferred embodiment performs the sample-and-hold processing to be described below, thereby obtaining information that is required to control the data write operation appropriately (e.g., servo information and wobbling information). By carrying out the following operations, it is possible to avoid the unfavorable situation where the removal of the spike waveform alters the contents of information included in the read signal and deteriorates the accuracy of the servo information and wobbling information.

Hereinafter, the sample-and-hold processing will be described with reference to FIGS. 7 and 8. FIG. 7 is a flowchart showing the respective processing steps of the sample-and-hold processing to be carried out on the read signal before a mark starts being formed. In forming respective marks, the processing steps shown in FIG. 7 may be carried out by the controller 109 itself mainly but may also be carried out by other components as well under instructions from the controller 109. FIG. 8 is a timing diagram showing how a processed signal is generated in the optical disc drive 100.

The sample-and-hold processing to be described below is carried out by the respective sample-and-hold sections 121, 131 and 142 of the focus/tracking servo regulator 106 shown in FIG. 3, the wobble detector 107 shown in FIG. 4 and the R-OPC detector 108 shown in FIG. 5 in response to the sample-and-hold signal supplied from the controller 109. In the following description, the sample-and-hold signal with a high level will be referred to herein as a “hold signal” and the sample-and-hold signal with a low level will be referred to herein as a “sample signal”. Also, the output signals of the sample-and-hold sections 121, 131 and 142 will be referred to herein as “processed signals”. Those processed signals are obtained by subjecting the read signals, which have been output from the optical pickup 103, to predetermined processing. Thus, the sample-and-hold sections 121, 131 and 142 that perform such processing may also be called “read signal processors”.

First, in Step 701, the optical pickup 103 radiates a laser beam having a predetermined intensity toward the optical disc 101 in accordance with the NRZI signal shown in portion (a) of FIG. 8. In this example, marks are formed as shown in portion (b) of FIG. 8 in accordance with the NRZI signal. Next, in Step 702, the optical pickup 103 detects the reflected laser beam, thereby generating a read signal such as that shown in portion (c) of FIG. 8. As can be seen from portion (c) of FIG. 8, the saturated spike waveform portions, exceeding the dynamic range that is indicated by the dashed line, have been removed.

Next, in Step 703, the controller 109 generates and outputs hold signals to the focus/tracking servo regulator 106, wobble detector 107 and R-OPC detector 108 at timings as determined by the parameter that was defined by the CPU 146. Specifically, portion (d) of FIG. 8 shows the waveform of the servo controlling sample-and-hold signal to be supplied to the focus/tracking servo regulator 106. Portion (e) of FIG. 8 shows the waveform of the wobble detecting sample-and-hold signal to be supplied to the wobble detector 107. Portion (f) of FIG. 8 shows the waveform of the R-OPC sample-and-hold signal to be supplied to the R-OPC detector 108.

The controller 109 has generated the hold signals H as shown in portions (d) and (e) of FIG. 8. In this example, the hold signals are high-level signals. Also, each of those hold signals rises before a mark starts being formed and even before the interval L to detect the saturated spike waveform begins. Since the controller 109 generates the NRZI signal, the controller 109 can easily see that the leading edge of each hold signal precedes the beginning of the interval L.

Next, in Step 704, each of the sample-and-hold sections 121, 131 and 142 of the focus/tracking servo regulator 106, wobble detector 107 and R-OPC detector 108 outputs a processed signal that is held at the level of the read signal when the hold signal was received at the sample-and-hold section 121, 131 or 142. In this case, the level of the read signal is held lower than that of the spike waveform portion.

Subsequently, in Step 705, the controller 109 determines whether or not the waveform of the read signal includes the spike waveform portion or the saturated spike waveform portion. This decision can be made by determining whether or not the duration in which the strong laser beam has been radiated from the light source has reached the length of the interval L in the CD-R, for example. If the controller 109 has decided that the interval L has not passed yet and that there is the saturated spike waveform portion, then the procedure returns to Step 706. On the other hand, if the controller 109 has decided that the interval L has already passed and that there is no saturated spike waveform portion, then the procedure advances to Step 707.

In Step 706, the controller 109 continuously outputs the same hold signals, and the sample-and-hold sections 121 and 131 of the focus/tracking servo regulator 106 and the wobble detector 107 also continuously output the same processed signals that are still held at the levels described above.

The processing step 707 is carried out after the interval L has passed (i.e., after the spike waveform has disappeared) and while the mark is being formed. At such a timing, the controller 109 generates the sample signal S. As used herein, the sample signal is synonymous with the trailing edge of the hold signal and is a low-level signal. Once the sample signal has been generated, the procedure advances to Step 708.

In Step 708, the sample-and-hold sections 121 and 131 output processed signals, of which the levels correspond to that of the read signal, in response to the sample signal S. For example, the read signal may be output as it is as the processed signals.

As a result of the processing steps described above, the sample-and-hold sections 121 and 131 output a processed signal such as that shown in portion (g) of FIG. 8. As shown in portion (g) of FIG. 8, the processed signal maintains the previous level when the sample-and-hold signal is high (i.e., in response to the hold signal), but is identical to the read signal when the sample-and-hold signal is low (i.e., in response to the sample signal).

In this manner, a processed signal, which is free from the unwanted effect of the spike waveform, is generated based on the read signal to be detected while marks are being formed and on the sample-and-hold signal. The resultant processed signal is smoothed by the smoothing sections 123 and 133 as described above. As a result, accurate servo information and wobbling information can be obtained.

It should be noted that the R-OPC sample-and-hold signal may define the same sample and hold timings as those already described for the R-OPC detector 108. However, the sample-and-hold section 142 in the R-OPC detector 108 needs to sample a value of the read signal after the spike waveform has disappeared. Accordingly, it is not until the interval L has passed that the controller 109 generates the sample signal. The sample-and-hold section 142 also needs to sample a value of the read signal representing a space on which the weak laser beam is being focused. For that reason, it is at least before the interval L for the next mark begins that the controller 109 generates the sample signal.

As described above, the processing steps shown in FIG. 7 are carried out for a single mark formed. Accordingly, when the next mark is formed, the same set of processing steps will need to be carried out all over again from the beginning. In that case, the controller 109 may continuously output the same sample signal and start outputting the hold signal again before the spike waveform is produced for the next mark.

In the preferred embodiment described above, the read signal is held before a mark starts being formed and while the spike waveform is being produced but is sampled in the other periods, thereby generating a processed signal. The processed signal is not affected by the spike waveform at all. Thus, control signals, generated based on the processed signal, are not affected by the spike waveform, either. As a result, the servo control, motor control, write clock control and optical power control can be carried out appropriately.

By removing the spike waveform and yet by adjusting the gain such that the remaining waveform falls within the dynamic range, the SNR can be increased as compared with a situation where the overall read signal, as well as the spike waveform, is included within the dynamic range.

Optionally, the optical disc drive 100 may also be designed to perform the sample-and-hold processing of the preferred embodiment described above and the conventional sample-and-hold processing selectively.

Embodiment 2

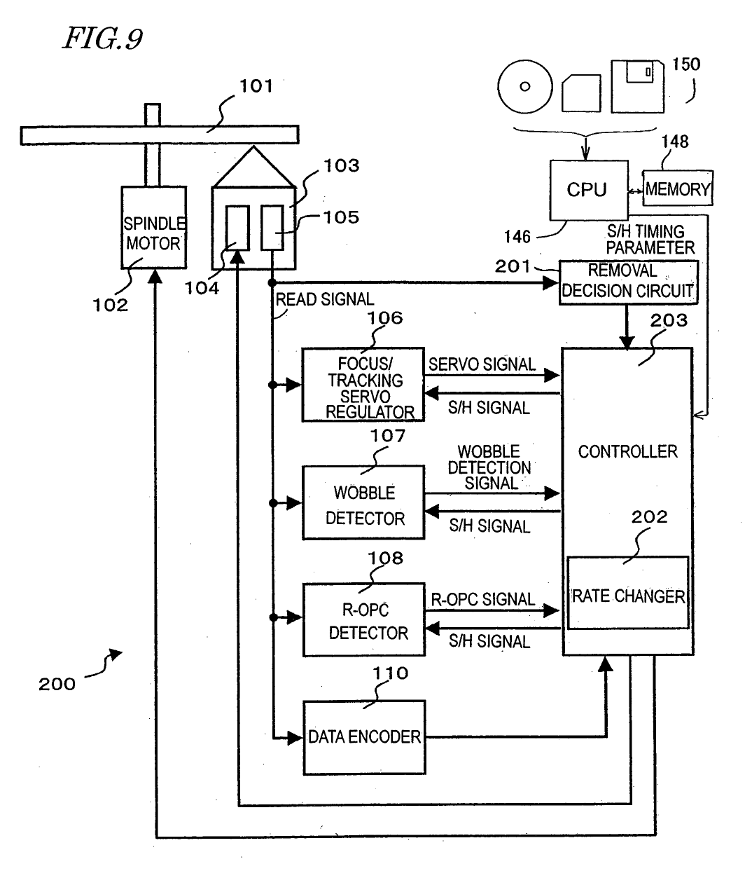

FIG. 9 is a block diagram showing a configuration for an optical disc drive 200 according to the second specific preferred embodiment of the present invention. The optical disc drive 200 includes not only all components of the optical disc drive 100 of the first preferred embodiment shown in FIG. 1 but also a removal decision circuit 201 as well. In addition, the controller 203 of the optical disc drive 200 further includes another functional block, which will be referred to herein as a “rate changer 202”. Hereinafter, the configurations and operations of these additional components will be described. It should be noted that each component of the optical disc drive 200, having substantially the same function as the counterpart of the optical disc drive 100 shown in FIG. 1, will be identified by the same reference numeral and the description thereof will be omitted herein. Although the controller 109 of the optical disc drive 100 and the controller 203 of the optical disc drive 200 are identified by two different reference numerals, the controller 203 of the optical disc drive 200 has the same functions as the controller 109 of the optical disc drive 100 except for the function of the rate changer 202.

The rate changer 202 changes the write rates at which data is written on the optical disc 101 and then outputs a control signal, representing the newly selected rate, to respective components of the optical disc drive 200. That is to say, the rate changer 202 changes the rotational velocities of the spindle motor 102 and re-defines the power of the laser radiation to form marks according to the newly selected rotational velocity. Furthermore, the rate changer 202 also changes the read signal detection sensitivity according to the laser power redefined.

For example, to increase the write rate, the marks need to be formed at a higher rate. For that purpose, the rate changer 202 outputs a control signal to the optical pickup 103, thereby increasing the laser radiation power during mark recording. However, if the laser radiation power is increased, then the quantity of reflected light increases, thus raising the level of the read signal. Thus, the rate changer 202 further outputs a control signal to the optical pickup 103, thereby adjusting the gain such that the spike waveform portion, appearing in the waveform of the read signal just before the mark starts being recorded, is removed and that the remaining waveform portions fall within the predetermined dynamic range.

The removal decision circuit 201 determines whether or not the spike waveform portion has been removed from the waveform of the read signal by the optical pickup 103. For example, if the maximum level of the read signal obtained reaches the upper limit of the dynamic range, then the removal decision circuit 201 may determine that the spike waveform portion has been removed successfully. Otherwise, the removal decision circuit 201 may determine that the spike waveform portion has not yet been removed. Once the removal decision circuit 201 has determined that the spike waveform portion has been removed successfully, the controller 203 outputs a sample-and-hold signal to the focus/tracking servo regulator 106 and wobble detector 107. In the interval in which the spike waveform portion is removed, the sample-and-hold signal is preferably a hold signal instructing that the read signal should be held at the level just before the interval begins. After the interval has passed, the sample-and-hold signal is preferably a sample signal instructing that the read signal should be sampled as it is. It should be noted that the removal decision circuit 201 can determine whether or not the spike waveform portion has been removed from each of the read signals that are output from the photodetector of the optical pickup shown in FIG. 2.

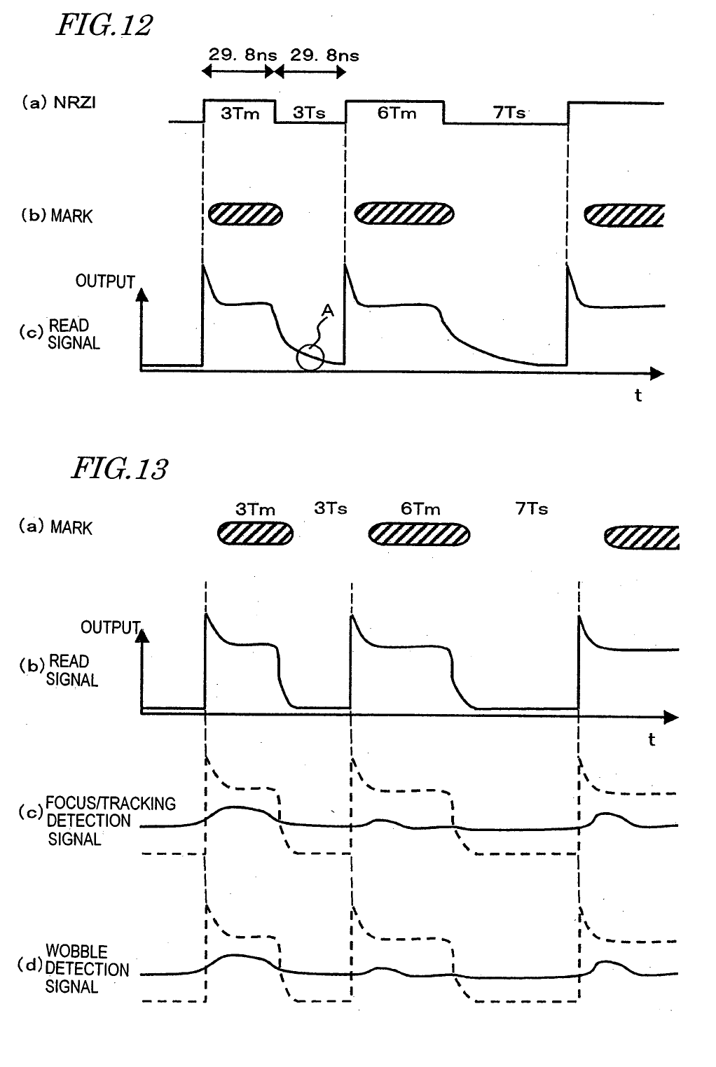

Hereinafter, it will be described how the optical disc drive 200 of the second preferred embodiment operates. To control the write operation adaptively according to the write rate, the optical disc drive 200 switches the modes of operations appropriately. Specifically, if the write rate is relatively high, the marks are formed at a high frequency, the intensity of the laser radiation is high, and the maximum level of the spike waveform is also high. In that case, the optical pickup 103 should cut off the spike waveform portion. Consequently, the optical disc drive 200 performs the same sample-and-hold processing as the optical disc drive 100, thereby generating the processed signal, servo signal and so on. On the other hand, if the write rate is relatively low, the marks are formed at a low frequency, the intensity of the laser radiation is low, and the maximum level of the spike waveform is also low. Thus, the optical pickup 103 does not have to cut off the spike waveform portion. In that case, the optical disc drive 200 samples and smoothes the overall read signal, thereby generating the servo signal and so on. If the write rate is low, the optical disc drive 200 of the second preferred embodiment does not perform the sample-and-hold processing done by the optical disc drive 100 of the first preferred embodiment. Consequently, when the write rate is low, the optical disc drive 200 performs the same processing as that shown in FIG. 12. Even so, no serious problems should arise because the spike waveform has a relatively low maximum level. It should be noted that the “low write rate” refers to not only a situation where the rotational velocity of the optical disc is lower than a reference value during a data write operation, but also a situation where the rotational velocity of the optical disc is certainly higher than the reference value but the difference is relatively small. For example, if a 2× or 3× write operation is carried out by an optical disc drive having a 48× write capability, then the write rate may also be regarded as “low”.

Optionally, the optical pickup 103 may remove the spike waveform portions from only the read signals k and l detected at the outer detecting areas 111-1 and 111-2 of the photodetector 111 shown in FIG. 2 or from only the read signals m and n detected at the inner detecting areas 111-3 and 111-4 thereof. This is because if the laser beam spot has significantly deviated from the target recording track due to some optically produced imbalance, then the levels (i.e., amplitudes) of the read signals obtained at the outer detecting areas will be greatly different from those of the read signals obtained at the inner detecting areas. Also, the removal decision circuit 201 may determine whether the spike waveform portions have been removed from the read signals obtained at the outer detecting areas or from the read signals obtained at the inner detecting areas. In that case, the optical disc drive 200 may perform the same sample-and-hold processing as that done by the optical disc drive 100 on the read signals from which the spike waveform portions have been removed and may perform overall sampling processing on the read signals from which the spike waveform portions have not been removed. Anyway, by detecting only such read signals as having unwanted spike waveform portions that exceed the predetermined dynamic range and by removing only those spike waveform portions selectively, the error rate can be reduced significantly.

In the first and second specific preferred embodiments of the present invention described above, the focus/tracking servo regulator 106, wobble detector 107 and R-OPC detector 108 add and subtract the read signals. Alternatively, at least some of the additions and subtractions may be performed by the optical pickup 103. Also, the additions, subtractions, sampling/holding and smoothing may be carried out in a different order.

Also, in portions (d) and (e) of FIG. 8, the hold signals are generated completely synchronously with the spike waveform portions. However, the present invention is in no way limited to such a specific preferred embodiment. Optionally, at least one hold signal may be generated during a sampling period shown in FIG. 8 to perform a hold operation. For example, if a hold signal is asserted just before a mark has been formed and is negated right after the mark has been formed, then the read signal falls steeply when the hold signal switches into a sample signal. Then, the servo signal and wobble detection signal can be generated easily when data needs to be written at a high rate.

In the first and second preferred embodiments of the present invention described above, the optical disc 101 is supposed to be a CD-R. Alternatively, the optical disc 101 may also be a DVD-R or any other type of optical disc. When marks are formed on a DVD-R, however, the laser radiation has a comb-shaped output waveform. Accordingly, the read signal also has a similar comb-shaped waveform. To smooth such a comb-shaped waveform, a smoothing section (not shown) may be additionally provided as a preprocessor for the sample-and-hold section 142 or the adder 141 in the R-OPC detector 108 shown in FIG. 5. The additional smoothing section may be a so-called “low-pass filter” which pass frequencies of at most about 10 MHz, for example. The smoothing section processes the comb-shaped signal into a smoothed signal. Optionally, a peak detector for detecting high-level components of the comb-shaped waveform may be further provided as another preprocessor for the sample-and-hold section 142. As can be seen, the present invention is effectively applicable for use in any storage medium that produces a spike waveform while marks are recorded thereon.

Also, in the first and second preferred embodiments described above, the servo signal and wobble detection signal are made up of a read signal representing a mark and a read signal representing a space between the marks. Alternatively, the servo information and wobbling information may also be derived by sampling only the read signal representing the space. In that case, the gain of the optical pickup should be adjusted such that the spike waveform portion, which appears in the waveform of the read signal just after the space has been read, is removed and that the remaining portion of the waveform falls within the predetermined dynamic range. In this manner, the SNR can be increased. Furthermore, even if the optical pickup does not remove the spike waveform portion, the spike waveform portion of the read signal may be held and the other portion thereof may be sampled in response to the sample-and-hold signal. Then, the unfavorable effects of the spike waveform can also be eliminated. In the preferred embodiments described above, the present invention is used in servo control, write clock control and optical power control. However, the present invention is also applicable for use in any other type of control.

In the preferred embodiments of the present invention described above, the memory, CPU and controller are regarded as respective components of the optical disc drive. However, these components may make up a discrete digital signal processor (DSP) chip. If the memory 148, CPU 146 and controller 109 of the optical disc drive 100 of the first preferred embodiment are integrated together into a single DSP chip, then the DSP chip generates a sample-and-hold signal instructing the optical pickup 103 to remove the spike waveform portions. Thus, the effects achieved by the optical disc drive 100 of the first preferred embodiment are also achievable. Optionally, such a DSP chip may include a switch that may change the modes of operation from the sample-and-hold processing of the present invention into the conventional sample-and-hold processing, or vice versa. In that case, in building the DSP chip in an optical disc drive including a conventional focus/tracking servo regulator, the manufacturer of the optical disc drive may turn the switch such that the conventional sample-and-hold processing is selected. On the other hand, in building the DSP chip in an optical disc drive including a focus/tracking servo regulator that can contribute to the sample-and-hold processing of the present invention, the manufacturer of the optical disc drive may turn the switch such that the sample-and-hold processing of the present invention is selected. Also, if the memory 148, CPU 146 and controller 203 of the optical disc drive 200 of the second preferred embodiment are integrated together into a single DSP chip, then the DSP chip changes the sample-and-hold signals depending on whether or not the spike waveform portions have been removed from the waveform of the read signal according to the specific write rate. Thus, the effects achieved by the optical disc drive 200 of the second preferred embodiment are also achievable.

According to various preferred embodiments of the present invention described above, a read signal, supplied from an optical pickup, is output as a signal that is held at a predetermined level in an interval that begins just before a mark starts being formed and that ends while the mark is being formed. Once that interval has passed, however, the read signal is output as a signal with a level corresponding to that of the read signal. The output signal is not affected by a spike waveform portion that is produced during the interval including a mark recording period. Thus, by using such a signal, the write operation can be controlled appropriately while the mark is being formed.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

What is claimed is:

1. An optical disc drive, which performs a data write operation on an optical disc by irradiating the optical disc with light such that a plurality of marks are formed on the optical disc, the optical disc drive comprising:
an optical head including a light source and a photodetector and for outputting a first read signal by getting the light emitted from the light source, reflected from the optical disc, and then detected by the photodetector;
a read signal processor for processing the first read signal received into a second read signal and outputting the second read signal in response to one of a first control signal and a second control signal, wherein the second read signal output by the read signal processor in response to the first control signal is held at a predetermined level, while the second read signal output by the read signal processor in response to the second control signal has a level corresponding to that of the first read signal; and
a controller for generating the first and second control signals and outputting the first control signal during a first period and the second control signal during a second period following the first period, respectively, the first period beginning before the marks are formed and ending while the marks are being formed,
wherein the optical disc drive controls the data write operation in accordance with the second read signal that has been output from the read signal processor.

2. The optical disc drive of claim 1, wherein the first read signal exhibits a spike waveform during the first period, and
wherein the controller generates the second control signal after the spike waveform has disappeared.

3. The optical disc drive of claim 2, wherein the controller determines, by the amount of time that has passed since light having an intensity high enough to form the marks started to be emitted from the light source, whether the spike waveform has disappeared or not.

4. The optical disc drive of claim 3, wherein the read signal processor defines the predetermined value to be lower than the level of the spike waveform.

5. The optical disc drive of claim 1, wherein the optical head outputs the first read signal by cutting off its waveform portions having levels that exceed a predetermined dynamic range.

6. The optical disc drive of claim 5, wherein the optical head outputs the first read signal by cutting off portions of the spike waveform.

7. The optical disc drive of claim 6, wherein the optical head outputs the first read signal having a gain that falls within the predetermined dynamic range.

8. The optical disc drive of claim 1, further comprising an averaging processor for averaging the second read signal received from the read signal processor and outputting an averaged second read signal,
wherein the optical disc drive controls the data write operation in accordance with the averaged second read signal.

9. The optical disc drive of claim 1, wherein the optical disc drive controls the data write operation by at least one of servo control, write clock control, motor control, and optical power control techniques.

10. A method of performing a data write operation on an optical disc by irradiating the optical disc with light such that a plurality of marks are formed on the optical disc, the method comprising the steps of:
detecting the light that has been emitted from a light source and then reflected from the optical disc;
outputting a first read signal that represents the light detected;
processing the first read signal into a second read signal and outputting the second read signal in response to one of a first control signal and a second control signal, wherein the second read signal being output in response to the first control signal is held at a predetermined level, while the second read signal being output in response to the second control signal has a level corresponding to that of the first read signal;
generating the first and second control signals and outputting the first control signal during a first period and the second control signal during a second period following the first period, respectively, the first period beginning before the marks are formed and ending while the marks are being formed; and
controlling the data write operation in accordance with the second read signal.

11. A computer program product for use with an optical disc drive including an optical head, a read signal processor and a controller and performing a data write operation on an optical disc by irradiating the optical disc with light such that a plurality of marks are formed on the optical disc, the optical head including a light source that emits the light and a photodetector that detects the light, wherein the computer program product causes the optical disc drive to perform steps of:
emitting the light emitted from the light source;
detecting the light, which has been reflected from the optical disc, by means of the photodetector;
outputting a first read signal, representing the light detected, from the optical head;
generating a second read signal at the read signal processor in response to one of a first control signal and a second control signal, wherein the second read signal being output in response to the first control signal is held at a predetermined level, while the second read signal being output in response to the second control signal has a level corresponding to that of the first read signal;
generating the first and second control signals at the controller during a first period and during a second period following the first period, respectively, the first period beginning before the marks are formed and ending while the marks are being formed; and
controlling the data write operation in accordance with the second read signal.

12. A control processor, which is included in an optical disc drive and which selectively operates in one of a first operation mode and a second operation mode, the optical disc drive performing a data write operation on an optical disc by irradiating the optical disc with light such that a plurality of marks are formed on the optical disc, the optical disc drive comprising
an optical head including a light source and a photodetector and outputting a first read signal by getting the light emitted from the light source, reflected from the optical disc, and then detected by the photodetector, and
a read signal processor for processing the first read signal received into a second read signal and outputting the second read signal in response to one of a first control signal and a second control signal, wherein the second read signal output by the read signal processor in response to the first control signal is held at a predetermined level, while the second read signal output by the read signal processor in response to the second control signal has a level corresponding to that of the first read signal, and
wherein while operating in the first operation mode, the control processor generates and outputs the first control signal during a first period and the second control signal during a second period following the first period, respectively, the first period beginning before the marks are formed and ending while the marks are being formed, and
wherein while operating in the second operation mode, the control processor generates and outputs the first control signal during a third period and the second control signal during a fourth period following the third period, respectively, the third period not overlapping with the first period.
